(19) United States
(12) Patent Application Publication
(10) Pub. No.: US 2009/0315004 A1
(43) Pub. Date: Dec. 24, 2009

(54) Container Lifting Device

(76) Inventors: Andres Joseph Draxl, Gauteng (ZA); Henry Jansen Van Rensburg, Gauteng (ZA)

Correspondence Address: MORGAN LEWIS & BOCKIUS LLP, 1111 PENNSYLVANIA AVENUE NW, WASHINGTON, DC, 20004, US

(21) Appl. No.: 12/306,967

(22) PCT Filed: Jul. 3, 2007
(86) PCT No.: PCT/IB07/01819

§ 371 Date: Dec. 30, 2008

(30) Foreign Application Priority Data
Jul. 3, 2006 (ZA) 2006/05448

(51) Int. Cl. B66F 7/26

(52) U.S. Cl. 254/45

(57) ABSTRACT

A lifting device for lifting a shipping container off a flat bed of a truck is described. The device comprises a cross member and a pair of arms connected thereto. The upper ends of the arms engage in the connector castings at the upper end of an end of the container. The cross member carries near its ends a pair of guides through which a pair of legs are slidably mounted. The upper end of each leg has an outwardly directed lug. A block and tackle unit is connected between the lug and the cross member. There is a lifting device at each end of the container. When the unit is actuated the container is lifted off the flat bed so that the truck can move away and the container thereafter lowered on to the ground.

This invention relates to shipping containers.

A shipping container is normally a parallipipedal unit formed by a frame that is clad with steel walls with an openable part or door at one of its ends. Shipping containers are normally of the following dimensions viz 6.1 m or 12.2 m in length, 2440 mm in width and 2590 mm in height. There are similarly dimensioned shipping containers which are an additional 310 mm in height (called herein “high containers”). The shipping container has connector castings at its corners whereby it may be secured to adjacently stacked containers and also for lifting and other handling purposes.

Shipping containers are usually transported by ship, by flat bed rail cars and trucks. At their ultimate destination the shipping containers are unloaded for unloading, possible reloading and also for possible short term storage purposes.

This invention is concerned with container loading and off-loading devices.

Many different systems have been designed and used for loading containers on and off trailers. Most of the known systems require cranes or gantries or sophisticated hydraulic lifting devices such as grapples.

A problem that has been experienced is that often it is necessary to load or off-load containers from trucks in remote areas where cranes, gantries or the like are not available.

According to one aspect of the present invention there is provided a loading device comprising a frame including
a horizontal cross-member which is longer than the width of a container and having parts whereby it may be connected to the lower end of an end of the shipping container;
a pair of arms respectively connected each at one end to the ends of the cross-member, the arms being adapted at their other ends to engage the connector castings at the upper corners of the same end of the shipping container;
a pair of legs having ground engaging means at their lower ends and being slidably connected to cross-member respectively;
upper connecting devices adapted to be connected to a first part of a lifting means, each said connecting device being connected to the upper end of each leg; and
lower connecting means on the cross-member at locations below the upper connecting devices and each being adapted to engage a second part of the lifting means.

There are preferably lifting means provided each with one part connected to an upper connecting device and the other part connected to the lower connecting means. Preferably the lifting means comprises a block and tackle unit. It is desirable for an outwardly extending lug to be provided at the upper end of each leg to carry respectively the upper connecting devices. Such devices conveniently may comprise a member having at its end an eye that may be engaged by a hook or similar part attached to the lifting means.

Each leg preferably has transverse openings therethrough into which stops may be introduced to support the container at any desired height.

According to another aspect of the invention there is provided the combination of a shipping container having connector castings at the corners of each end and a pair of lifting means as set forth above located at each end in the following manner, viz
the said other ends of the arms of each device are connected to the connector castings at the upper end of each end of the container,
the cross-members are operatively respectively connected to the connector castings at the lower ends of the ends of the container and
lifting means are introduced with one part of each lifting means connected to an upper connecting device and the other part connected to the cross-member at the said location, whereby
   on actuating the lifting means the container may be raised in such a manner that it is carried by the legs to enable the truck on which the container was carried can move away from the container and thereafter the container can be lowered on to the ground. The lifting means may also be able to lift the container when it is desired to load it on to a flat bed truck, and the truck is moved so that the container is under the flat bed and then lowered on to the flat bed.

An intermediate member is preferably connected to the lower connector castings at each end of the container and connection means are provided which connect the intermediate member to the cross-member so that the location of the container relative to the legs may be varied to compensate for mislocation of the truck under the container when the flat bed of the truck is driven into position under the container.

An embodiment of the invention will now be described by way of example with reference to the accompanying drawings.

In the drawings:—

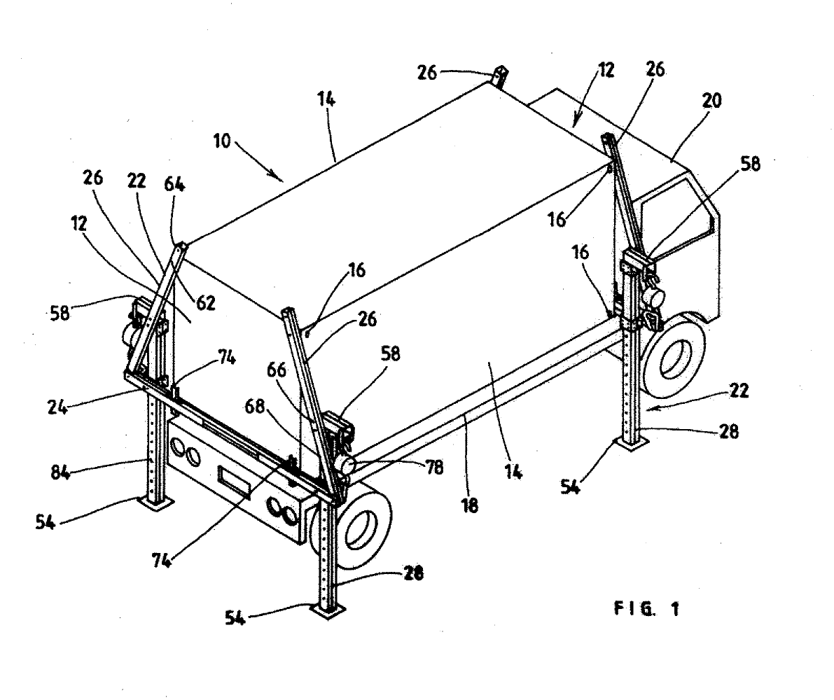

FIG. 1 is a perspective view from the rear and above of a flat bed truck with a container lifted slightly off the flat bed of the truck by a pair of lifting devices of the invention;

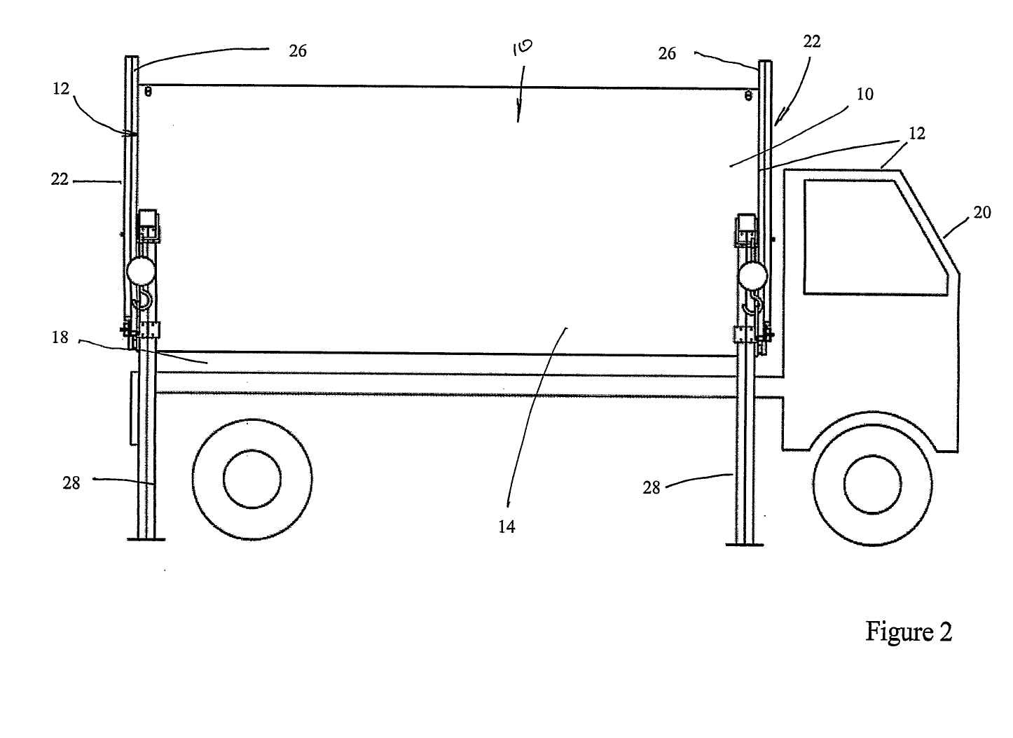

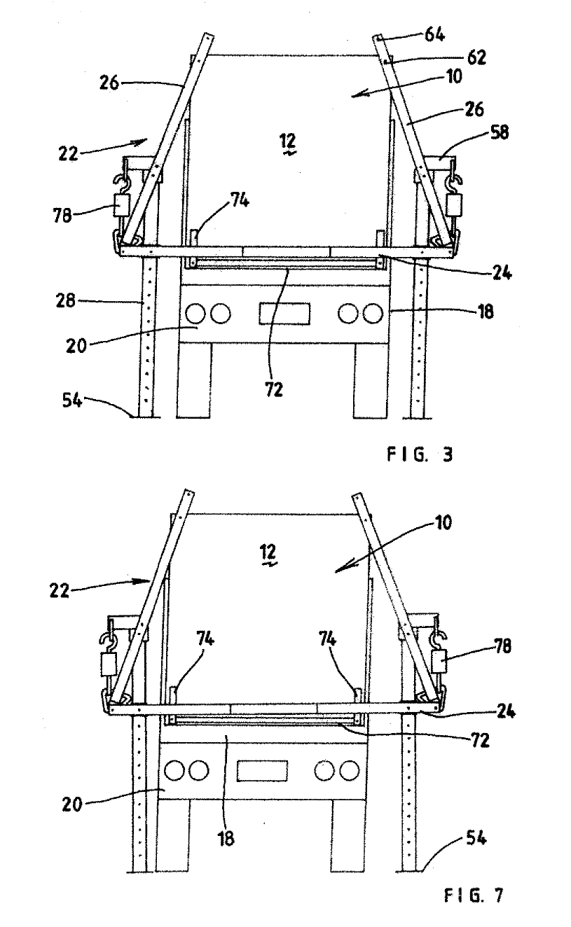

FIGS. 2, 3 and 4 are respectively a side view, a rear view and a perspective view from the rear and below of the parts shown in FIG. 1;

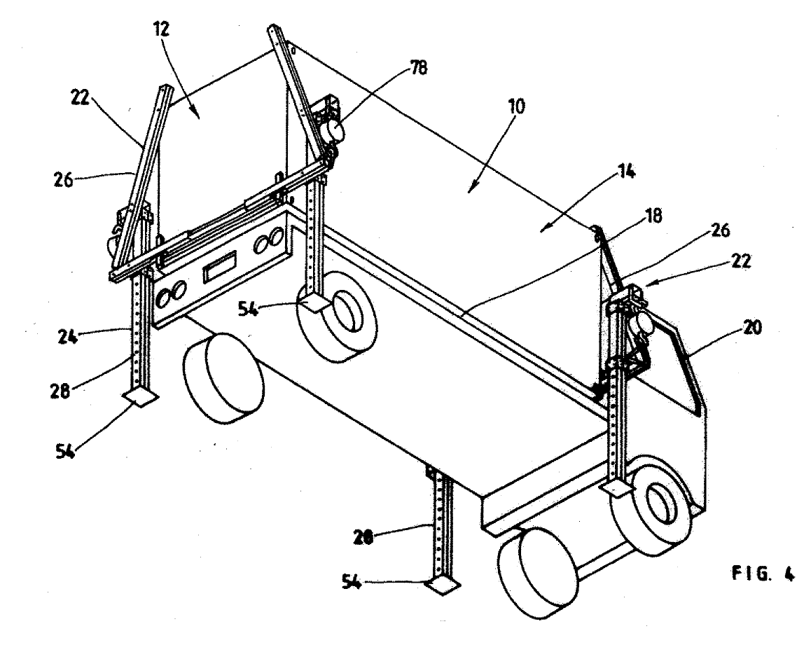

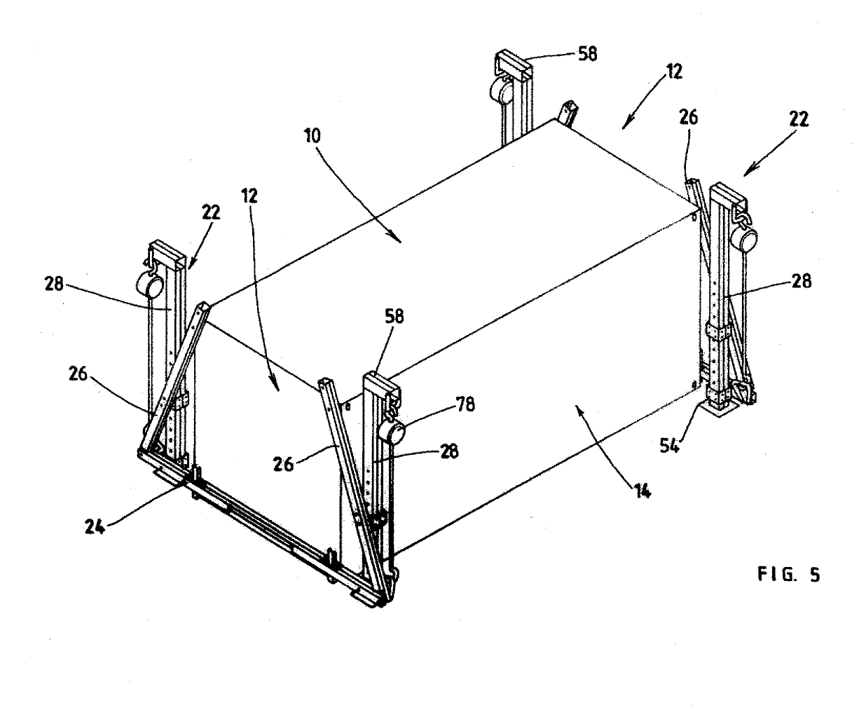

FIG. 5 is a perspective view similar to FIG. 1 showing the container and lifting devices when the container is lowered on to the ground;

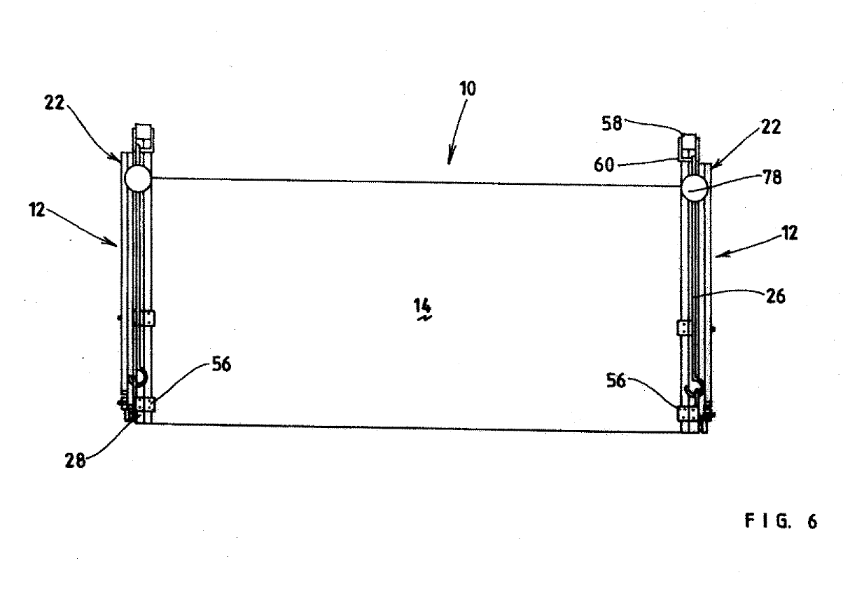

FIG. 6 is a side view of the parts as shown in FIG. 5;

FIG. 7 is a rear view of the container being lowered on to the flat bed of the truck where the latter is slightly misaligned;

FIGS. 8 and 9 are enlarged details of FIG. 1;

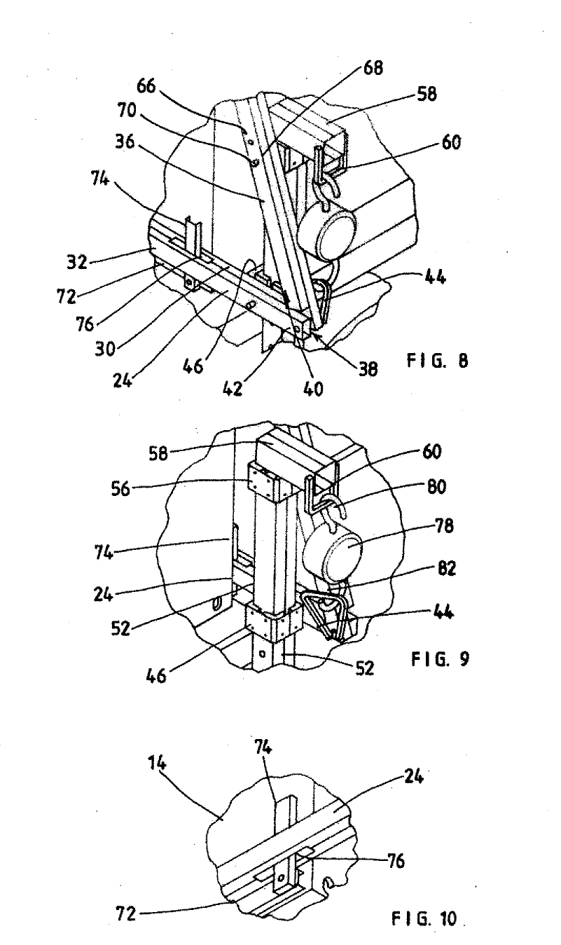

FIG. 10 is an enlarged detail of FIG. 4;

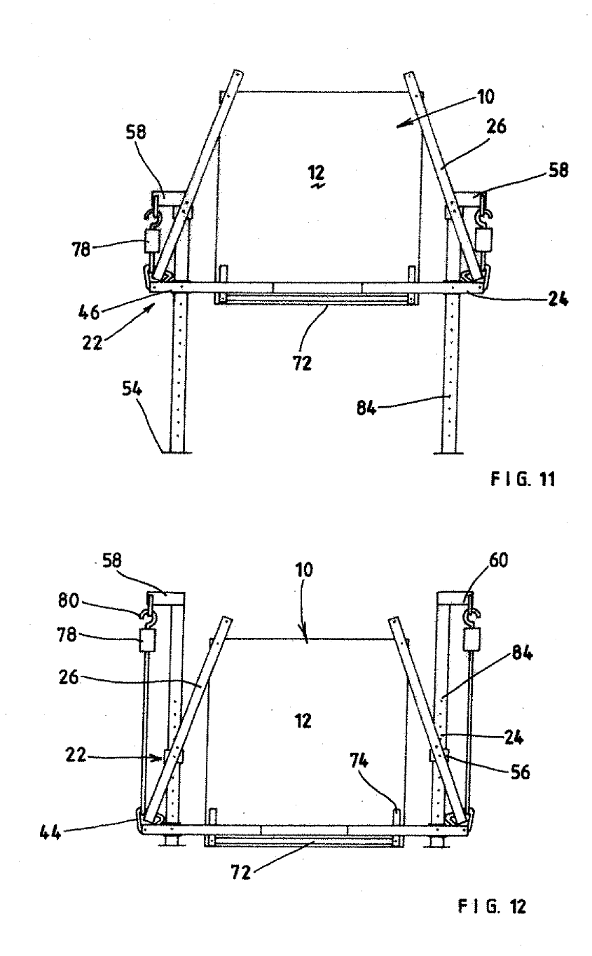

FIG. 11 is a rear view of the container suspended on the lifting devices; and

FIG. 12 is a rear view showing the container lowered on to the ground.

Referring now to the drawings, there is shown a shipping container 10. The container 10 is a parallelipipedal unit which is 12.2 m long, 2.59 metres high and 2.44 metres wide. At the corner of each end 12 and side 14 the container 10 has a connecting casting (shown diagrammatically on the sides 14 only) whereby the container 10 may be lifted or connected to adjacent containers in a container ship. The container 10 is shown having been lifted up above the flat bed 18 of a truck 20 which has transported it, the shipping container 10, from a first location to a delivery location. The truck 20 is shown diagrammatically in the drawings.

At each end 12 of the container 10 is a lifting device 22 of the invention. The lifting devices 22 serve the following purposes as will be described viz (i) lifting the container off the flat bed 18 so that the truck 20 may move elsewhere for further use and then (ii) for lowering the container 10 on to the ground. The lifting device 22 comprises a frame consisting of a cross-member 24, a pair of arms 26, and a pair of legs 28.

The cross-member 24 is located at the lower end of the end 12 of the container 10 and extends beyond either side thereof. The cross-member 24 is connected to the container 10 as will be described below. The cross-member 24 as well as the arms 26 comprise inner and an outer box section members respectively 30 and 32 and 34 and 36. At each end 38 the inner box section member 30 of the cross-member 24 terminates short of the outer member 32. At its lower end 40 of each arm, the outer box member 36 terminates short of the inner box member 34 (best shown in FIG. 8). The inner surfaces of the inner box member 34 and the outer member 32 where these extend beyond their adjacent box members 34 and the outer member 32 where these extend beyond their adjacent box members bear against each other and a pin 42 passes through each pair of parts so that the lower ends of the arms 26 are pivotally connected to the ends of the cross-member 24.

The pins 42 extend beyond the cross-member 10 and engage in one corner of a triangular connector 44 (best shown in FIG. 9). A suitable securing plate (not shown) is provided to hold each connector 44 on to the pin 42.

A robust square section vertical guide 46 is bolted on to the cross-member 10 spaced inwardly of each of its ends. A vertical leg 28 comprising two rectangular box section members 52 is slidably mounted in each guide 46. At its lower end, each leg 28 has a cross plate 54 forming a ground engaging foot. At its upper end each leg 50 has a reinforcing sleeve 56 above which is an outwardly extending box section lug 58 that terminates above the corresponding end of the cross-member 10. A “U” shaped shackle 60 is connected to the lower end of each lug 58.

The upper end of each arm 24 has a pair of inner and outer spaced openings 62 and 64. Attachment members (not shown) pass through the inner openings 62 and engage the connector castings 16. Near its lower end, each armed 24 further has a pair of upper and lower openings 66 and 68. A pin 70 projects from the sleeve 56 through the lower opening 68.

An intermediate member 72 runs along the lower portion of each end 12 and is connected to the lower connector castings. A pair of upwardly extending, vertical, channel-shaped members 74 (best shown in FIG. 10) are carried by the intermediate member 72 at a location close to the ends of the container 10. The cross-member 24 has a longitudinal slot 76 near each end through which the member 72 passes. This arrangement serves two purposes. First, it holds the cross-member 24 close to the container 10. Second, it enables the cross-member 24 to move longitudinally for the purposes which will be described.

A block and tackle unit 78 is provided between each lug 58 and the end of the cross-member 24. The unit 78 has upper and lower connecting hooks 80 and 82 which engage respectively the shackle 60 and the triangular connector 44.

The legs 28 have cross-bores 84 through which carrier pins (not shown) can pass to hold the container 10 in a position raised relative to the feet 54 if so required. A set of low friction plastic liners 86 (see FIG. 1) are provided on the insides of the guides 46 to permit easy movement of the legs 50 therethrough.

The lifting device 22 operates as follows. The various parts are connected as above described to a container 10 on a flat bed 18 of a truck 20. The block and tackle units 78 are operated to draw the cross-member 24 outwardly and hence to lift the container 10 off the flat bed 18. When there is sufficient clearance the truck 20 can then be driven away. By means of the block and tackle units 78, the container 10 is lowered on to the ground as shown in FIGS. 5, 6 and 12. The container can being be unloaded and otherwise used e.g. as a short-term storage device or it can be loaded with reverse cargo.

The re-positioning of the container 10 on the flat bed 18 follows substantially the reverse operations to those mentioned above. The lifting devices 22 are brought to the ends of the container 10 and connected as mentioned above. By means of the block and tackle units 78 the container 10 is lifted to an appropriate height. The truck 16 is now carefully manoeuvred into position so that the flat bed 18 is properly aligned with the container 10 which is now lowered thereon. The container 10 is secured to the flat bed 18. The block and tackle units 76 are manipulated so that the lifting devices 22 are no longer subject to the weight of the container 10 and are then removed from the container 10 and stored. The truck 16 can now transport the container 10 to its desired destination.

In the event that the truck 16 is not precisely located below the container 10, the container 10 is man-handled sideways swinging on the upper connector castings 16 until the container 10 is correctly located thereabove the flat bed 18 (as shown in FIG. 7). The container 10 is then lowered. During this movement of the container 10 the upright channel shaped members 74 move within the slots 76.

The lifting devices 22 are used in the same manner when the container is a high container (as defined above) save as follows:—The pins 70 are passed through the upper openings in the arms 26. The attachment means connect the outer openings 64 to the connector castings at the upper end of the container 10.

The legs 28 are extremely robust and may desirably be sufficiently strong so that each can carry a mass of ten tonnes even though the mass of the container 10 and its contents is normally no more than twenty two tonnes or on rare occasions (where the shipper has to pay financial penalties) as much as twenty five tonnes. The extra strength of the legs may be necessary where the ground, is uneven and more weight must be carried by one of the legs than the others.

It will be noted that the configuration of the cross-member, the arms and the upper part of the container form a substantially rigid load carrying framework. This enables the lifting devices to be sufficiently strong enough to lift heavy containers whilst comprising a cross-member and arms which are relatively light and can easily be manhandled for assembly and removal. The legs too and other parts of the lifting devices can easily be lifted by work men for assembly and removal. The disassembled lifting devices can be stored on the flat bed of the truck (which will have suitable arrangements to secure the parts) or in the containers when not in use or may be transported for use in a light delivery truck or van.

It will be appreciated that a lifting device 10 as described in this invention is required on each end of a container. The lifting device 22 is per force relatively lightweight as little or no bracing is required.

This invention is not limited to the precise constructional details as hereinbefore described and illustrated in the drawings. For example the cross-member and arms, as well as the legs, may comprise non-square section members e.g. cylindrical units. Other lifting devices may be used.

1. A lifting device comprising a frame including
a horizontal cross-member which is longer than the width of the container and having parts whereby it may be connected to the lower end of an end of the shipping container.
a pair of arms respectively connected at one end thereof to the ends of the cross-member, the arms being adapted at their other ends to engage the connector castings at the upper corners of an end of the shipping container,
a pair of legs having ground engaging means at their lower ends and being slidably connected to the cross-member respectively,
upper connecting devices connected respectively to the legs and being adapted to be connected to a first part of lifting means, and
the lower connecting means on the cross-member at locations below the upper connecting devices and each being adapted to engage a second part of the lifting means.

2. A lifting device as claimed in claim 1 wherein the lifting means comprises a block and tackle unit.

3. A lifting device as claimed in claim 1 wherein the cross-member carries a plurality of vertical guides in which the legs are slidably mounted.

4. A lifting device as claimed in claim 3 wherein low friction sliders are provided in the guides to facilitate movement of the legs therein.

5. A lifting device as claimed in claim 1 further comprising an intermediate member which is adapted to be connected to the lower connector castings and which carry means engaging the cross-member in such a way that the cross-member can move longitudinally relative to the intermediate member so that the location of the container relative to the legs may be varied to compensate for mislocation of the truck under the container when the flat bed of the truck is driven into position under the container.

6. A lifting device as claimed in claim 5 wherein the cross member is provided with longitudinal slots therein and wherein the said means comprise members carried by the intermediate member and being slidably received within the slots.

7. A lifting device as claimed in claim 1 wherein each leg is provided with an outwardly directed lug to which the upper part of the lifting means may be connected.

8. A lifting device as claimed in claim 7 wherein the outer end of the lug has a shackle attached thereto to which the upper part of the lifting means may be removably connected.

9. A lifting device as claimed in claim 7 wherein each arm is connectable to the leg above the cross-member.

10. A lifting device as claimed in claim 1 comprising a pivot pin connected at each end of the cross member to the lower end of the associated arm.

11. A lifting device as claimed in claim 10 wherein the pivot pin carries a shackle to which the lower end of the lifting means may be connected.

12. The combination of two loading devices as claimed in claim 1 with a shipping container having connector castings at the corners of its ends,
wherein
the said other ends of the arms of each device are connected to the connector castings at the upper end of each end of the container,
the cross-member is operatively connected to the connector castings at the lower ends of the ends of the container and
a plurality of lifting means are provided with one part of each lifting means connected to an upper connecting device and the other part connected to the cross-member at the said locations whereby
on actuating the lifting means a shipping container when mounted on the flat bed of a truck may be raised off the flat bed in such a manner that it is carried by the legs to enable the truck can move away from the container and thereafter the container can be lowered on to the ground.

13. (canceled)

14. (canceled)
